(19) United States
(12) Patent Application Publication
(10) Pub. No.: US 2006/0170843 A1
(43) Pub. Date: Aug. 3, 2006

(54) OCB mode reflective liquid crystal display device

(75) Inventors: Chiu-Lien Yang, Miao-Li (TW); Wei-Li Ling, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/317,175

(22) Filed: Dec. 23, 2005

(30) Foreign Application Priority Data
Jan. 28, 2005 (TW) 94102622

(51) Int. Cl. G02F 1/1335

(52) U.S. Cl. 349/113

(57) ABSTRACT

A reflective LCD device (20) includes a first substrate (21) and a second substrate (22). A liquid crystal layer (25) having liquid crystal molecules is interposed between the first and second substrates. The liquid crystal molecules are bend-aligned to cause the reflective liquid crystal display device to operate in an optically compensated bend (OCB) mode. A first alignment layer (231) and a second alignment (232) layer are respectively disposed between the liquid crystal layer and the first and second substrates. One or more retardation films and a compensation layer can compensate for color, with the compensation layer also improving the viewing angle. This helps ensure that the reflective LCD device provides a good quality display image. In addition, the alignment and a pretilt angle of the liquid crystal molecules ensure that the liquid crystal molecules realign in a very short time upon a change in a driving electric field.

### FIELD OF THE INVENTION

The present invention relates to liquid crystal display (LCD) devices, and more particularly to a reflection type LCD device.

### GENERAL BACKGROUND

Among LCD products, there have been the following three types of LCD devices commercially available: a reflection type LCD device utilizing ambient light, a transmission type LCD device utilizing backlight, and a semi-transmission type LCD device equipped with a half mirror and a backlight.

The reflection type LCD has been widely used as a portable display device such as in an electronic calculator or a personal digital assistant (PDA), because this type of LCD does not require a backlight and has low power consumption.

As shown in FIG. 4, a typical reflection type LCD 10 includes a first substrate 11, a second substrate 12 opposite to the first substrate 11, and a liquid crystal layer 15 disposed between the first substrate 11 and the second substrate 12. A first alignment layer 131 and a reflection electrode 141 are disposed between the liquid crystal layer 15 and the first substrate 11. A second alignment layer 132 and a common electrode 142 are disposed between the liquid crystal layer 15 and the second substrate 12. A polarizer 16 is disposed at an outer surface of the second substrate 12.

The liquid crystal layer 15 includes a plurality of liquid crystal molecules (not labeled) of the twisted nematic (TN) type. The molecules align according to an electric field generated when a voltage is applied.

However, the reflection type LCD 10 has the following problems. The TN type molecules have a slow response time and may take unduly long to display images. In addition, the viewing angle characteristics of the reflection type LCD 10 may not be wide enough to meet the desired standards for a modern, high quality display.

What is needed, therefore, is a liquid crystal display device that overcomes the above-described deficiencies.

### SUMMARY

In a preferred embodiment, a reflective liquid crystal display (LCD) device includes a first substrate and a second substrate. A liquid crystal layer having liquid crystal molecules is interposed between the first and second substrates. The liquid crystal molecules are bend-aligned to cause the reflective liquid crystal display device to operate in an optically compensated bend (OCB) mode. A first alignment layer and a second alignment layer are respectively disposed between the liquid crystal layer and the first and second substrates.

The reflective LCD device preferably further includes a first retardation film and a second retardation film both disposed at an outer surface of the first substrate.

According to another embodiment, the reflective LCD device may further include a compensation layer disposed between the first retardation film and the first substrate.

In certain of various embodiments of the reflective LCD device, one or more retardation films and the compensation layer can compensate for color, with the compensation layer also improving the viewing angle. This helps ensure that the reflective LCD device provides a good quality display image. In addition, the alignment and a pretilt angle of the liquid crystal molecules ensure that the liquid crystal molecules realign in a very short time upon a change in a driving electric field.

Other advantages and novel features will become more apparent from the following detailed description when taken in conjunction with the accompanying drawings.

### BRIEF DESCRIPTION OF THE DRAWINGS

FIG. 1 is a schematic, exploded, side cross-sectional view of part of a reflective LCD device according to a first embodiment of the present invention.

FIG. 2 is a schematic, exploded, side cross-sectional view of part of a reflective LCD device according to a second embodiment of the present invention.

FIG. 3 is a schematic, exploded, side cross-sectional view of part of a reflective LCD device according to a third embodiment of the present invention.

FIG. 4 is a schematic, exploded, side cross-sectional view of part of a conventional reflection type LCD.

### DETAILED DESCRIPTION OF PREFERRED EMBODIMENTS

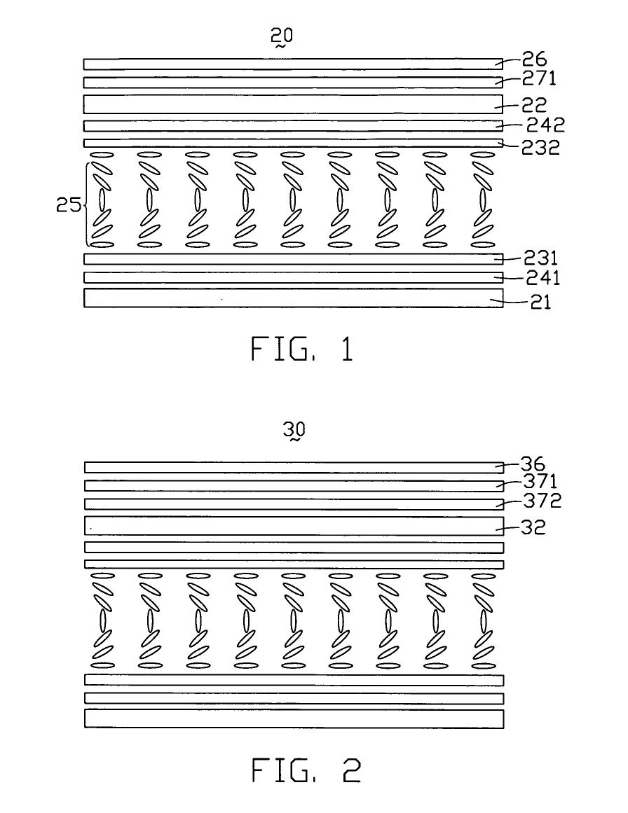

FIG. 1 is a schematic, exploded, side cross-sectional view of part of a reflective LCD device 20 according to a first embodiment of the present invention. The LCD device 20 includes a first substrate 21, a second substrate 22 disposed parallel to and spaced apart from the first substrate 21, and a liquid crystal layer 25 having liquid crystal molecules (not labeled) sandwiched between the substrates 21 and 22.

A first alignment layer 231 and a reflection electrode 241 are disposed between the liquid crystal layer 25 and the first substrate 21. A second alignment layer 232 and a common electrode 242 are disposed between the liquid crystal layer 25 and the second substrate 22. A polarizer 26 is disposed at an outer side of the second substrate 22. The liquid crystal molecules are bend-aligned so that the reflective LCD device 20 operates in an optically compensated bend (OCB) mode. A pretilt angle of the liquid crystal molecules adjacent to the substrates 21 and 22 is in a range of 0° to 15°. The reflection electrode 241 is made of metal with a high reflective ratio, such as aluminum (Al). The common electrode 242 is made of a transparent conductive material, such as indium-tin-oxide (ITO) or indium-zinc-oxide (IZO).

A retardation film 271 is disposed between the polarizer 26 and the second substrate 22. The retardation film 271 is a quarter-wave plate.

The liquid crystal molecules in the reflective LCD device 20 are bend-aligned to have a pre-tilt angle, which ensures that the liquid crystal molecules can more easily adjust their orientation when a voltage is applied to the reflective LCD device 20 and a change in a driving electric field is effected. Thereby, the reflective LCD device 20 has a fast response time. Moreover, the retardation film 271 facilitates the reflective LCD device 20 to display a good quality image.

FIG. 2 is a schematic, exploded, side cross-sectional view of part of a reflective LCD device 30 according to a second embodiment of the present invention. The reflective LCD device 30 is similar to the reflective LCD device 20 of FIG. 1. However, the reflective LCD device 30 further includes a second retardation film 372, which is disposed between a first retardation film 371 and a second substrate 32. An optical axis of the second retardation film 372 maintains an angle θ₁ relative to a polarizing axis of a polarizer 36, and an optical axis of the first retardation film 371 maintains an angle of 2θ₁±45° relative to the polarizing axis of the polarizer 36. The second retardation film 372 is a half-wave plate.

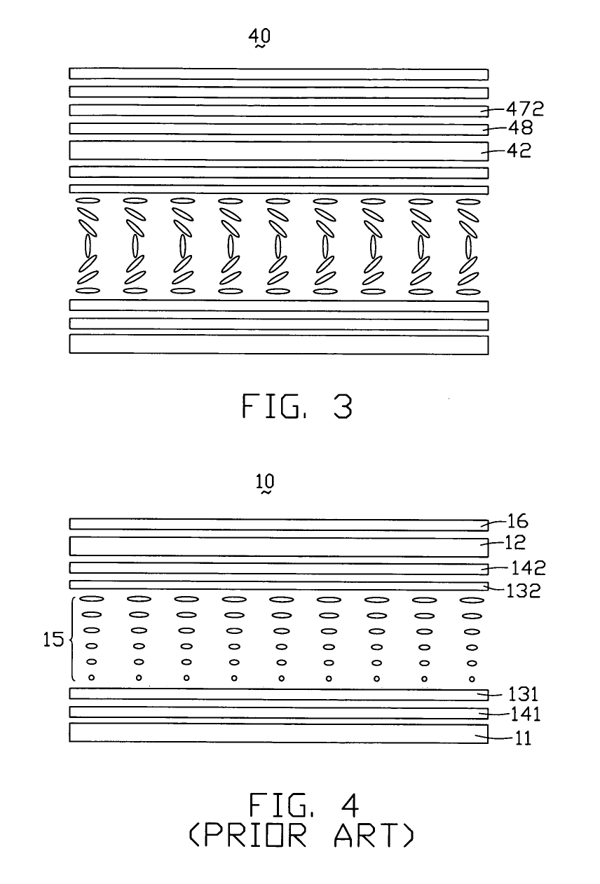

FIG. 3 is a schematic, exploded, side cross-sectional view of part of a reflective LCD device 40 according to a third embodiment of the present invention. The LCD reflective device 40 is similar to the reflective LCD device 30 of FIG. 2. However, the reflective LCD device 40 further includes a compensation layer 48 disposed between a second retardation film 472 and a second substrate 42. The compensation layer 48 improves the viewing angle characteristics of the reflective LCD device 40, and thereby improves the display quality of the reflective LCD device 40.

Liquid crystal molecules in the reflective LCD device 40 are bend-aligned to have a pre-tilt angle, which ensures that the liquid crystal molecules can more easily adjust their orientation when a voltage is applied to the reflective LCD device 40 and a change in a driving electric field is effected. Thereby, the reflective LCD device 40 has a fast response time. Moreover, the retardation films and the compensation layer 48 are used for compensating for color, so as to ensure that the reflective LCD device 40 displays a good quality image.

Various modifications and alterations of the above-described embodiments are possible. For example, the compensation layer may be a biaxial compensation film, a single compensation film, an A-plate compensation film, or a discotic molecular film. In addition, the LCD device may employ a single compensation layer at the first substrate instead of at the second substrate. Furthermore, any one or more or all of the retardation films and the compensation layer may be disposed on or at inner surfaces of either of the first and/or second substrates.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A reflective liquid crystal display device, comprising:
a first substrate and a second substrate;
a liquid crystal layer having liquid crystal molecules interposed between the first and second substrates, the liquid crystal molecules being bend-aligned to cause the reflective liquid crystal display device to operate in an optically compensated bend (OCB) mode; and
a first alignment layer disposed between the liquid crystal layer and the first substrate, and a second alignment layer disposed between the liquid crystal layer and the second substrate.

2. The reflective liquid crystal display device as claimed in claim 1, wherein a pretilt angle of liquid crystal molecules adjacent to the first and second substrates is in a range of 0° to 15°.

3. The reflective liquid crystal display device as claimed in claim 1, further comprising a common electrode disposed between the second substrate and the second alignment layer, and a reflection electrode disposed between the first substrate and the first alignment layer.

4. The reflective liquid crystal display device as claimed in claim 1, further comprising a polarizer disposed at an outer side of the first substrate.

5. The reflective liquid crystal display device as claimed in claim 4, further comprising a first retardation film disposed between the polarizer and the second substrate.

6. The reflective liquid crystal display device as claimed in claim 5, further comprising a second retardation film disposed between the second substrate and the first retardation film.

7. The reflective liquid crystal display device as claimed in claim 6, wherein the first retardation film is a quarter-wave plate, and the second retardation film is a half-wave plate.

8. The reflective liquid crystal display device as claimed in claim 6, further comprising a compensation layer disposed between the second retardation film and the second substrate.

9. The liquid crystal display device as claimed in claim 7, wherein an optical axis of the second retardation film maintains an angle θ₁ relative to a polarizing axis of the polarizer, and an optical axis of the first retardation film maintains an angle of 2θ₁±45° relative to the polarizing axis of the polarizer.
